(19) United States
(12) Patent Application Publication
(10) Pub. No.: US 2026/0276113 A1
(43) Pub. Date: Sep. 17, 2026

(54) HIGH PURITY FLEXIBLE CONDUIT ASSEMBLY AND METHOD

(71) Applicant: Hose Master, LLC, Cleveland, OH (US)

(72) Inventors: John Schmitmeyer, Cleveland, OH (US); Adam S. Ference, Westlake, OH (US)

(21) Appl. No.: 19/673,846

(22) Filed: May 11, 2026

Related U.S. Application Data
(60) Provisional application No. 63/803,405, filed on Jan. 1, 0001.
(60) Provisional application No. 63/839,144, filed on Jul. 6, 2025.

(51) Int. Cl. F16L 11/15; C25F 3/24; F16L 13/02

(52) U.S. Cl. CPC F16L 11/15; C25F 3/24; F16L 13/02

(57) ABSTRACT

A flexible conduit assembly is provided along with a method of using and method of manufacturing wherein the assembly includes an annular corrugated hose body with an inner diametrical surface and an outer diametrical surface, the annular corrugated hose body further comprising a first end and a second end being spaced by the hose body; first and second end connectors coupled respectively to the first and second ends to form a fluid-tight connection with the annular corrugated hose body; and the inner diametrical surface having a surface finish at or below RA25 μin.

### CROSS REFERENCES TO RELATED APPLICATIONS

The following application claims priority under 35 U.S.C. § 119 (e) to U.S. Provisional Patent Application Ser. No. 63/839,144 filed Jul. 6, 2025 entitled HIGH PURITY FLEXIBLE CONDUIT ASSEMBLY AND METHOD and to U.S. Provisional Patent Application Ser. No. 63/803,405 filed May 9, 2025 entitled HIGH PURITY FLEXIBLE CONDUIT ASSEMBLY AND METHOD. The above-identified applications are incorporated herein by reference in their entireties for all purposes.

### TECHNICAL FIELD

The present disclosure generally relates to a high purity flexible conduit assembly and method, and more particularly a conduit or hose system that is designed and configured to a minimal particulate standard to create a clean internal system for enclosing wiring, fluids, gases, solids, any combination thereof, and the like. The high purity flexible conduit assembly further comprises a method of use and method of manufacturing.

### BACKGROUND

Tubing is being used to transport fluids for cooling, fuel, wiring, and the like. However, the current method using linear sections of pipes/tubes that are manually bent is labor intensive. Moreover, a need exists to be able to bend the tubing is a more efficient way. In addition, because of the extreme length of travel of the tubing, it is desirous to provide conduit for the gases, liquids, wires, and the like, with a minimal amount of internal friction.

### SUMMARY

One aspect of the present disclosure comprises: a flexible conduit hose assembly having an annular corrugated hose body with an inner diametrical surface and an outer diametrical surface, the annular corrugated hose body further comprising a first end and a second end being spaced by said hose body; first and second end connectors coupled respectively to said first and second ends to form a fluid-tight connection with said annular corrugated hose body; and said inner diametrical surface having a surface finish at or below RA20 μin.

Another aspect of the present disclosure comprises: a high purity flexible conduit hose assembly having an annular corrugated hose body with an inner diametrical surface having a surface finish at or below RA16 μin and an outer diametrical surface, the annular corrugated hose body further comprising a first end and a second end being spaced by said annular corrugated hose body; first and second end connectors coupled respectively to said first and second ends to form a fluid-tight connection with said annular corrugated hose body; a tapered conical end portion on said first and second end connectors having an annular pocket configured to receive said first or second ends of said annular corrugated hose body; and a series of undulating crests and valleys on said annular corrugated hose body such that the valleys form an internal diameter and the crests form an external diameter of said annular corrugated hose body; wherein the first and second ends of said annular corrugated hose body form a body diameter by the extension of the corrugation from a valley toward a crest such that the body diameter at said first and second end is substantially equal to the inner diameter of the respective annular pocket of said first and second end connectors.

Yet another embodiment of the present disclosure comprises a method of manufacturing a flexible conduit hose assembly comprising the steps of: providing stainless steel sheet stock; electro-polishing the stainless steel sheet stock to achieve a surface finish at or below RA16 μin; forming the electro-polished stainless steel into an annular corrugated hose body having an inner diametrical surface and an outer diametrical surface, the annular corrugated hose body further comprising a first end and a second end being spaced by said annular corrugated hose body; machining first and second end connectors for coupling respectively to said first and second ends to form a fluid-tight connection with said annular corrugated hose body; electro-polishing said first and second end connectors to achieve a surface finish at or below RA16 μin; thermally coupling said first and second ends of said annular corrugated hose body to said first and second end connectors respectively to form said fluid-tight connection; and coiling said flexible conduit hose assembly onto storage coils.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals refer to like parts unless described otherwise throughout the drawings and in which:

FIG. 1 illustrates a high purity flexible conduit assembly constructed in accordance with one example embodiment of the present disclosure;

FIG. 2 illustrates an electro-polished strip that is used to form at least a portion of the high purity flexible conduit assembly in accordance with one example embodiment of the present disclosure;

FIG. 3A illustrates a partially sectioned end connector sectioned along lines 3-3 in FIG. 4B, the end connector is used to form the high purity flexible conduit assembly in one example embodiment;

FIG. 3B illustrates an end connector used to form the high purity flexible conduit assembly in another example embodiment;

FIG. 4A illustrates an upper section view sectioned along lines 4-4 in FIG. 4B and a lower outer view of a high purity flexible conduit assembly of indeterminant length in accordance with another embodiment of the present disclosure;

FIG. 4B illustrates an end view of a conduit assembly of FIG. 4A;

FIG. 5A is a magnified view of the end assembly for connecting one of the end connectors and an end of a corrugated metal hose body in accordance of one example embodiment of the present disclosure;

FIG. 5B is a magnified view of the end assembly for connecting one of the end connectors and an end of a corrugated metal hose body in accordance of another example embodiment of the present disclosure;

FIG. 6 illustrates a section view of an end connector shown in FIG. 3B used to form the high purity flexible conduit assembly in one example embodiment;

FIG. 7 illustrates a magnified view of the end assembly for connecting one of the end connectors and an end of a corrugated metal hose body prior to thermal coupling in accordance of one example embodiment of the present disclosure;

FIG. 8 illustrates a flexible high purity corrugated metal hose constructed in accordance with one example embodiment of the present disclosure; and

FIG. 9 illustrates a method a manufacturing a high purity flexible conduit assembly in one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

Moreover, skilled artisans will appreciate that some aspects of the objects or elements shown in the figures and/or embodiments were selected based on their ornamental design and not for any functional design or configuration. It is also possible that some functional or utilitarian elements shown in the figures and/or embodiments also have shapes or features selected purely for the appearance or ornamental design because the function or utility could be achieved with a different shape.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure generally relates to a high purity flexible conduit assembly and method, and more particularly a flexible conduit or hose system that is designed and configured to a minimal particulate standard to create a clean internal system for enclosing wiring, fluids, gases, solids, any combination thereof, and the like. The high purity flexible conduit assembly further comprises a method of use and method of manufacturing.

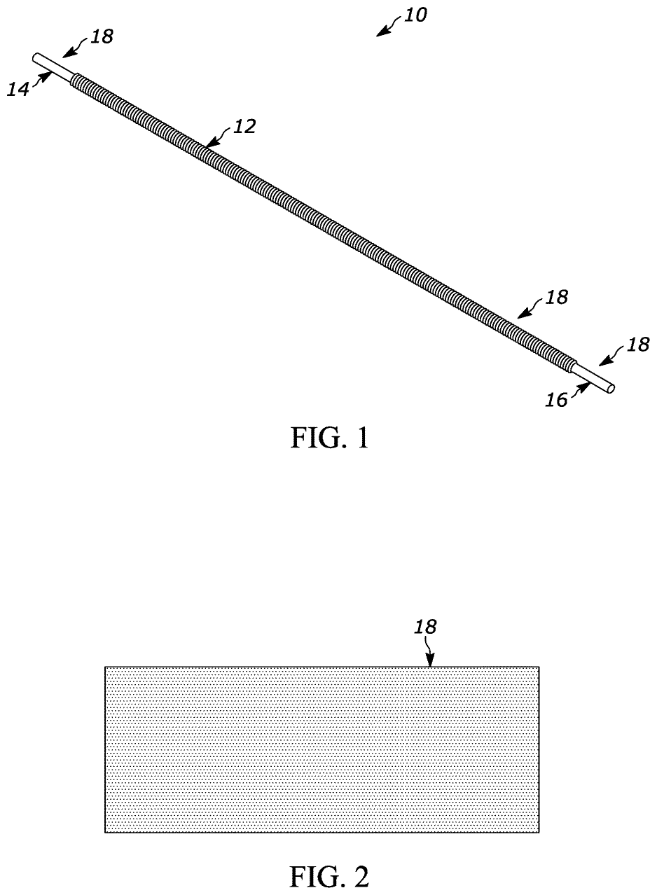

FIG. 1 illustrates a high purity flexible conduit assembly 10 constructed in accordance with one example embodiment of the present disclosure. The conduit assembly 10 comprises a flexible high purity corrugated metal hose 12 coupled to a high purity first end connector 14 and a high purity second end connector 16. In one example embodiment, the corrugated metal hose 12 and connectors 14, 16, have an internal diameter or (ID) surface finish ranging between an RA6-RA20 (Ra being a Roughness average in micro-inches μin). In another example embodiment, the ID has a surface finish ranging between RA4-RA16, having an average RA value of ten. In yet another example embodiment, the ID has a surface finish ranging between RA7-RA10. In one example embodiment, the end connectors 14, 16 are made from ASTM A269 steel that is tubularly formed.

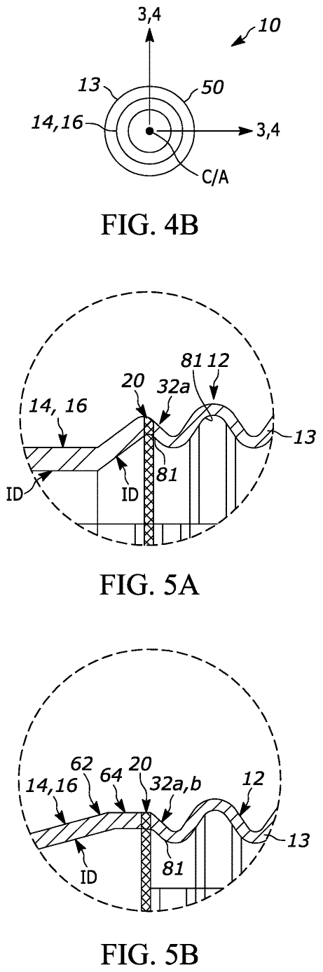

FIG. 2 illustrates an electro-polished strip 12 that is used to form at least a portion of the high purity flexible conduit assembly 10 in accordance with one example embodiment of the present disclosure. In one example embodiment, an electro-polished strip 18 is used to form the tubular corrugated metal hose 12 and tubular ends 14, 16, forming an internal control volume CV therein (see FIG. 4A). In one example embodiment, when applying a fluid-types seals or caps to the tubular ends, 14, 16, the control volume CV shown in FIG. 4A would be fluid tight and hold pressure and/or fluids without loss outside of the control volume CV. In another one example embodiment, the electro-polished steel 18 is ASTM A240 type 316 L stainless steel. In another example embodiment, the electro-polished steel 18 has a pre-processed surface finish ranging between RA4 and RA7.

In another example embodiment, the conduit assembly 10 undergoes an annealing process to be an annealed conduit assembly. The strip 12 could undergo other material processing, prior to fabricating the high purity flexible conduit assembly 10 or after the assembly is formed. In the illustrated example embodiment of FIGS. 1, 4 and 5, the end connectors 14 and 16 are welded to the ends of the corrugated hose 12 as illustrated in the magnified section view of FIGS. 5A and 5B.

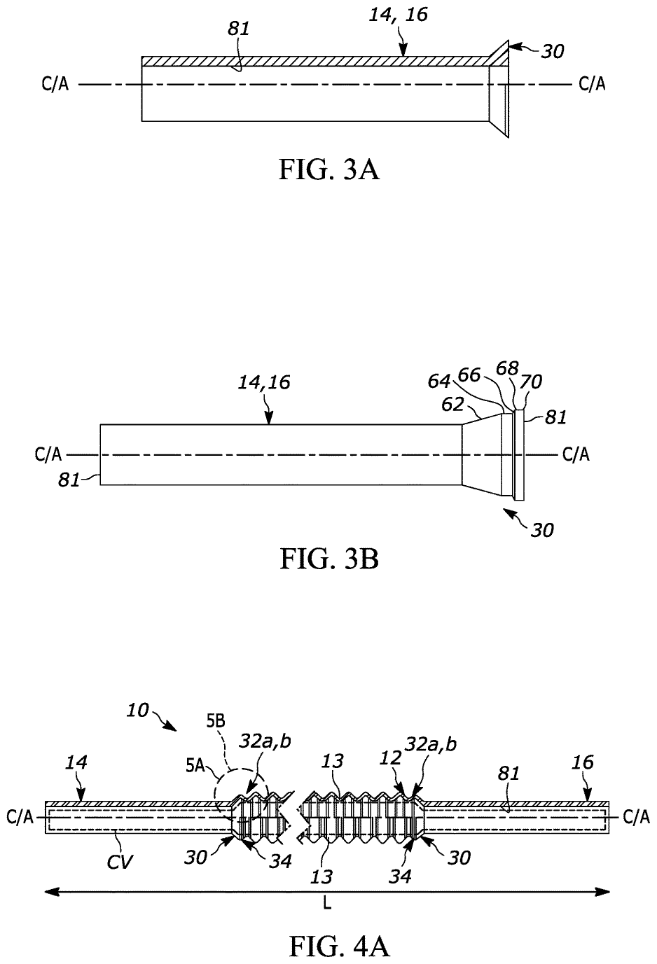

FIG. 3A illustrates an end connector 14 or 16 used to form the high purity flexible conduit assembly in accordance with one example embodiment. In another example embodiment, the assembly 10 indicated by the dimension L (see FIG. 4A) can be more than several hundred feet long while each end connector 14, 16 is only a few inches in length. A body 13 formed by the corrugation allows flexibility such that the assembly 10 whether two-hundred feet long with only one end connector at each end or combined with several assemblies 10 with a length L of a few feet allows for storing and shipping in a coil, similar to the transport of sheet stock or coiled steel. In one example embodiment, the end connectors 14, 16 are threaded or tapped to be selectively attached to another conduit assembly 10.

FIG. 3B illustrates an alternative embodiment of an end connector 14 or 16 used to form the high purity flexible conduit assembly. An oversized conical end 30 includes an outward taper 62 that returns to a flat portion 64. The flat portion 64 terminates into a machined incline 66 that returns to a first end of a terminal projection 68 and a second end of a terminal projection 70. The end connector 14, 16 is symmetrical about a central axis C/A and having a smooth machined finish. After a machining process, the end connector 14, 16 is electro-polished in one example embodiment, resulting in a smoother finish.

Returning to FIG. 4A, the drawing illustrates an upper section view and a lower outer view separated by a central axis C/A of a high purity flexible conduit assembly 10 of indeterminant length L in accordance with another embodiment of the present disclosure. Reference numeral 5 is a magnified view of the end assembly 14 or 16 for connecting one of the end connectors 14, 16 and an end of a corrugated metal hose body 12 in accordance with one example embodiment of the present disclosure to form an assembly 10, as shown in FIGS. 5A and 5B. In the illustrated example embodiment, the end connectors 14, 16 include an oversized annular conical end 30 (see FIGS. 3A and 3B) to fixedly couple with one of two ends 32a, 32b of the hose body 12 to form an annular fluid-tight connection 20, 34. In one example embodiment, the fluid-tight annular connection 20, 34 is formed by an annular weld 20 to the inner portion of the hose 12 and conical end 30.

In one example embodiment, the weld 20 is an annular weld, for example, a TIG weld that obtains full penetration between the end connections 14, 16 and body 13. In another example embodiment, the weld 20 is an annular weld, using for example, a welding torch that obtains full penetration between the end connections 14, 16 and body 13.

In yet another example embodiment, the annular fluid-tight connection 34 is formed by an annular weld 20 to the outer portion of the hose 12 and conical end 30. In another example embodiment, the end connections 14, 16 and/or undulating hose body 13 are formed in a similar process as described in Applicant's U.S. Pat. No. 7,121,591 (the '591 Patent), which is incorporated herein by reference in its entirety for all purposes, or by conventional means by roll forming sheet stock metal to a tubular shape, applying a seam weld along the ends, advancing the straight tube through a corrugator having a number of forming ridges to create the flexible ridges of the crests 58 and valleys 60. In yet another example embodiment, the inner annular weld connection 20 will have a machined finish to provide for cleaning and surface finish between RA4-RA10 with a maximum of RA20.

The forming of the flexible corrugated hose 12 can occur as described in the '591 Patent that minimizes the changes in the surface finish of the interior of the hose 12 from an RA4 slightly upward to an RA range around 10 to 16 with a max of 20 after processing when employed on the single material 18 and having an average RA value of ten, such as electro-polished stainless steel. This keeps the high quality surface finish desired to be at an RA20 or less after a polished rolling operation, extending the hose pitch, and/or any combination thereof. In another example embodiment, the high quality surface finish is RA16 or less following the forming process for the corrugation of the flexible high purity corrugated metal hose 12.

FIG. 4B illustrates an end view of a high purity flexible conduit assembly 10 as viewed along a central axis C/A, for example, in FIGS. 3A, 3B, or 4A, in one example embodiment. A body 13 or an annular body 50 forms an outer diameter and a non-tapering end of end connectors 14, 16 forms an inner diameter. The high purity flexible conduit assembly 10 can be viewed through from a first end connector 14 to a second end connector 16 while the corrugated metal hose body 12 is in a straight and non-flexed position.

Returning to FIGS. 5A and 5B, the drawings illustrate an internal section view of a high purity flexible conduit assembly 10 in alternative example embodiments. FIG. 5A illustrates an annular weld 20 between the conical end 30 of an end connector 14, 16 and an end 32a of a metal hose 12 and thermally coupled to a body 13. FIG. 5B illustrates an alternative embodiment wherein an annular weld 20 between a second end of a terminal projection 70 of an end connector 14, 16 and a body 13 of a metal hose 12 results in the reduction of first and second terminal projections 68, 70 (see FIG. 7) and a flat portion 64 exists thereafter. The metal hose 12 becomes thermally and integrally coupled to end connectors 14, 16 with minimal distortion in the level and smooth surface, forming a fluid-tight seal between the ends 14, 16 and body 13.

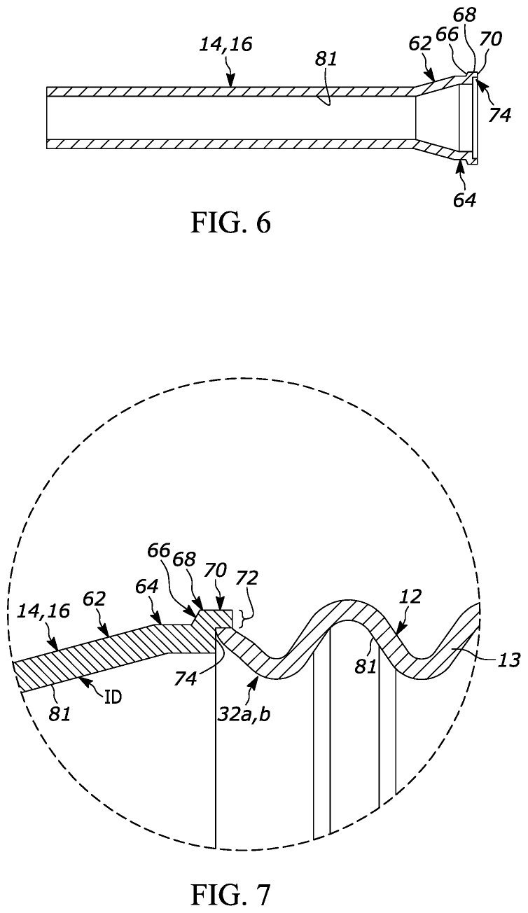

FIG. 6 illustrates a section view of an end connector 14, 16 shown in FIG. 3B used to form a high purity flexible conduit assembly 10 in one example embodiment. As mentioned above with reference to FIG. 3B, an outward taper 62 returns to a flat portion 64, which terminates into a machined incline 66 that returns to a first end of a terminal projection 68 and a second end of a terminal projection 70. The second end of the terminal projection 70 creates an isolated portion having a pocket 74 therein to mate with the end 32a or 32b of the corrugated metal hose 12.

FIG. 7 illustrates a magnified view of the end assembly 14 or 16 for connecting one of the end connectors 14, 16 and an end 32a, b of a corrugated metal hose body 12 in accordance with one example embodiment of the present disclosure to form an assembly. As shown, the end 32a or 32b of the body 13 of the corrugated metal hose 12 is nested in the pocket 74 of the end connector 14, 16 before any thermal coupling occurs. The shape and placement of the pocket 74 allows for optimum engagement and coupling with the ends 32a and 32b of the corrugated metal hose body 12. The annular end 32a, b of the corrugated metal hose 12 aligns co-axially with the receiving pocket 74 of the end connector 14, 16, which aids in efficient and repeatable assembly, and encourages a uniform and consistent thermal coupling. In one example embodiment, the end connector 14, 16 includes an elevated portion 72 having a certain thickness and consisting of a first end of a terminal projection 68 and a second end of a terminal projection 70, wherein the first end of the terminal projection 68 is further supported by a flat portion 64 of the end connectors 14, 16, while the second end of the terminal projection 70 remains unsupported until a thermal coupling occurs. Upon engagement of the end 32a, b of the corrugated metal hose 12 with the pocket 74 of the end connector 14, 16, an annular weld 20 can be formed.

In one example embodiment of the present disclosure, an annular weld 20 can be formed by heating the elevated portion 72 and consuming the first and second ends of the terminal projections 68, 70, thereby melting the respective terminal projections 68, 70 to form a smooth annular weld 20 between the corrugated metal hose 12 and the end connectors 14, 16. The weld puddle from heating the elevated portion 72 of the end connectors 14, 16 melts and rests in between the corrugated metal hose 12 and the end connectors 14, 16 to form a smooth transition between the respective components with minimal disturbance to the internal RA factor. Thus, in one example embodiment of the present disclosure, a single thermal welding operation can occur from an exterior surface that achieves adequate penetration to the interior surface of the high purity flexible conduit assembly 10 and resulting in a smooth internal and external transition.

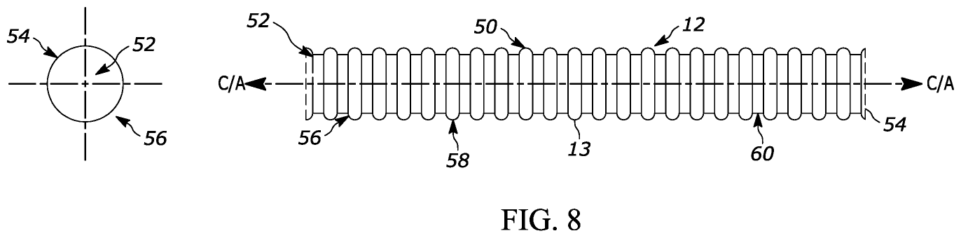

FIG. 8 illustrates a flexible high purity corrugated metal hose 12 constructed in accordance with one example embodiment of the present disclosure. In the illustrated example embodiment of FIG. 8, the metal hose 12 includes an annular body 50 formed with a single undulating material 52 extending from the internal diameter 54 to the external diameter 56. The single undulating material geometrically includes crests 58 and valleys 60 that are formed. The crests 58 and valleys 60 formed from the single undulating material are present on both the internal diameter 54 and external diameter 56. However, a crest 58 on the outer diameter 56 will be a valley 60 on the inner or internal diameter 54 and vice-versa. After the forming of the crests 58 and valleys 60, the RA surface finish value on the internal diameter 54 has minimal changes. In one example embodiment, the surface finish remained at the same RA value after processing to the final product. In another example embodiment, the starting surface finish RA4 value remained the same as the finished product RA4 value.

In one example embodiment, the electro-polished strip 18 is used to form the corrugated metal hose 12 and/or ends 14, 16. In the illustrated example embodiment of FIG. 8, the single piece of material 52 is electro-polished steel 18 made from ASTM A240 type 316L stainless steel and has a surface that is been pretreated with an electrochemical process. The forming of the undulations of the crests 58 and valleys 60 of the annular corrugated hose 12 can occur as described in the '591 Patent, or by conventional means previously described. One such conventional corrugated hose is sold by owner/assignee of the subject patent application under the commercial name PRESSUREFLEX HP®. The PRESSUREFLEX HP® specification and production sheet found at www. hosemaster. com is incorporated herein by reference in its entirety for all purposes.

When this forming process occurs on the single material 52 electro-polished steel 18, the high surface finish of the interior of the hose 12 is substantially maintained at a surface finish of RA16 or less after processing throughout the entire internal diameter 54, including the crests 58 and valleys 60 and welded connections. The processing includes, but is not limited to polished rolling operations, extending the hose pitch, welding, and/or any combination thereof. In another example embodiment, the high surface finish 81 of the interior of the hose 12 is substantially maintained at a surface finish of RA20 or less after processing.

In the illustrated example embodiment of FIG. 8, the corrugated electro-polished undulating hose 12 has a static bend of two inches. In another example embodiment of FIG. 8 the flexible annular corrugated electro-polished steel 18 forming the hose 12 has a static bend of at least two inches, an internal diameter 54 of approximately ¼ of one inch and an outside diameter of approximately 4/10 of one inch and a working pressure of 150 psi and burst pressure of approximately 600 psi with a working temperature range from =325 degrees F to 1000 degrees F with a wall thickness of approximately .012 inches and a final internal surface finish ranging between RA4 and RA10-RA16.

In another example embodiment, the hose 12 is certified to ISO 10380 type 3. In another example embodiment, the hose 12 is made from the single material 18 consisting of electro-polished steel made from ASTM A240 type 316L stainless steel having approximately an RA4 surface finish when in a flat or unformed strip. Upon applying the processes to form a undulating hose 12 from the strip 18 into the undulating corrugated hose body shown in FIG. 8, the internal diameter 54 surface finish change is minimized between RA4 and RA16, and no greater than RA20. The inner diameter 54 high surface finish is maintained by any one or combination of the processing comprising a polished rolling operation, welding operation, extending the hose pitch, and/or any combination thereof.

In one example embodiment, the ends 14, 16 are tapped, threaded, or capable of receiving a swage lock to couple other hose assemblies 10.

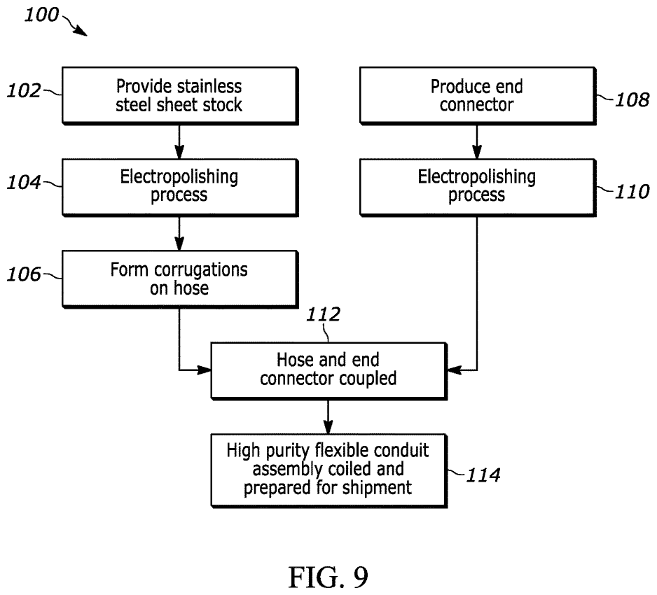

In FIG. 9, a method of manufacturing 100 is illustrated for one exemplary embodiment of the present disclosure. At 102, a stock of stainless steel sheet stock is provided to be processed into one embodiment of the foregoing disclosure. At step 104, the stainless steel stock 18 undergoes an electro-polishing operation, thereby decreasing the RA value of the surface when the body 13 of the hose 10 is formed. At 106, the electro-polished stainless steel is processed into a corrugated metal hose 12 by using minimal contacts to the interior surface, thereby preserving the low RA pre-processing value. Occurring simultaneously, before, or after the formation of the corrugated metal hose 12, the machining of the end connectors 14, 16 begins at step 108. At 110, the end connectors 14, 16 then undergo an electro-polishing process at step, resulting in a decrease in the RA value of the internal surface. The corrugated metal hose 12 is coupled to the end connectors 14, 16 at step 112. In one example embodiment, this coupling is achieved by placement of a thermal annual weld 20. At step 114, the high purity flexible conduit assembly 10 is coiled for efficient handling and prepared for shipment to customers.

In one example embodiment, the assembly 10 can be packed into a small shipping container because of the coil radius allowed by the corrugation. This advantageously allows for the shipping of the product to server farms, data farms, or energy suppliers that would have rows of equipment requiring cooling fluid, gas, or wires all benefiting and/or requiring the smooth inner surfaces of the hose assemblies 10. The assemblies 10 can then be customized to bend between the rows or stacks of equipment, and/or diverting where needed with straights and bends because of the corrugation. Conventional tubing would typically come in straight length piping and require manual bends in the non-linear areas of need between to or to the rows of equipment, which is manually labor intensive. The assemblies 10 can be extended by attaching the end connectors 14 and 16 to other end connectors 14 and 10 of other assemblies 10 by means of tapped and threaded ends and/or swaging. This means of connection is also possible to the supply of the gas, fluid, wires, and the like.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E₁, E₂, . . . Eₙ and that each embodiment E may have multiple parts A₁, B₁, C₁. . . . ₙn that (without further description) could be combined with other embodiments Eₙ, embodiment parts e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A flexible conduit hose assembly comprising:
an annular corrugated hose body having an inner diametrical surface and an outer diametrical surface, the annular corrugated hose body further comprising a first end and a second end being spaced by said annular corrugated hose body;
first and second end connectors coupled respectively to said first and second ends to form a fluid-tight connection with said annular corrugated hose body; and
said inner diametrical surface having a surface finish at or below RA20 μin.

2. The flexible conduit hose assembly of claim 1 wherein said inner diametrical surface having a surface finish at or below RA16 μin.

3. The flexible conduit hose assembly of claim 1 wherein said inner diametrical surface having a surface finish at or below RA12 μin.

4. The flexible conduit hose assembly of claim 1 wherein said inner diametrical surface having a surface finish at or below RA7 μin.

5. The flexible conduit hose assembly of claim 1 wherein said inner diametrical surface having a surface finish at or below RA4 μin.

6. The flexible conduit hose assembly of claim 1 wherein said fluid-tight connection is formed by a thermal weld to fixedly attach said first and second ends to said first and second end connectors respectively.

7. The flexible conduit hose assembly of claim 6 wherein said thermal weld is positioned on an outer portion and penetrates to an inner portion of said annular corrugated hose body and between said first and second ends respectively coupled to said first and second end connectors.

8. The flexible conduit hose assembly of claim 7 wherein the surface finish of said thermal weld on said inner portion of said annular corrugated hose body is at or below RA20 μin.

9. The flexible conduit hose assembly of claim 1 wherein said annular corrugated hose body is manufactured using an electro-polished steel.

10. The flexible conduit hose assembly of claim 9 wherein said electro-polished steel is manufactured using ASTM A240 type 316L stainless steel having a surface pretreated with an electrochemical process.

11. The flexible conduit hose assembly of claim 1 wherein said first and second end connectors are manufactured using an electro-polished steel.

12. A high purity flexible conduit hose assembly comprising:
an annular corrugated hose body having an inner diametrical surface having a surface finish at or below RA16 μin and an outer diametrical surface, the annular corrugated hose body further comprising a first end and a second end being spaced by said annular corrugated hose body;
first and second end connectors coupled respectively to said first and second ends to form a fluid-tight connection with said annular corrugated hose body;
a tapered conical end portion on said first and second end connectors having an annular pocket configured to receive said first or second ends of said annular corrugated hose body; and
a series of undulating crests and valleys on said annular corrugated hose body such that the valleys form an internal diameter and the crests form an external diameter of said annular corrugated hose body;
wherein the first and second ends of said annular corrugated hose body form a body diameter by the extension of the corrugation from a valley toward a crest such that the body diameter at said first and second end is substantially equal to the inner diameter of the respective annular pocket of said first and second end connectors.

13. The high purity flexible conduit hose assembly of claim 12 wherein said inner diametrical surface has a surface finish at or below RA 10 μin.

14. The high purity conduit hose assembly of claim 12 wherein said fluid-tight connection is formed by a thermal weld to fixedly attach said first and second ends to said first and second end connectors respectively.

15. The high purity conduit hose assembly of claim 12 wherein said annular corrugated hose body and said first and second end connectors are manufactured using an electro-polished steel.

16. A method of manufacturing a flexible conduit hose assembly comprising the steps of:
providing stainless steel sheet stock;
electro-polishing the stainless steel sheet stock to achieve a surface finish at or below RA16 μin;
forming the electro-polished stainless steel into an annular corrugated hose body having an inner diametrical surface and an outer diametrical surface, the annular corrugated hose body further comprising a first end and a second end being spaced by said annular corrugated hose body;
machining first and second end connectors for coupling respectively to said first and second ends to form a fluid-tight connection with said annular corrugated hose body;
electro-polishing said first and second end connectors to achieve a surface finish at or below RA16 μin;
thermally coupling said first and second ends of said annular corrugated hose body to said first and second end connectors respectively to form said fluid-tight connection; and
coiling said flexible conduit hose assembly onto storage coils.

17. The method of claim 16 wherein said flexible conduit hose assembly maintains an average surface finish at or below RA10 μin prior to coiling onto storage coils.

18. The method of claim 16 wherein said fluid-tight connection is achieved by a thermal weld positioned on an outer portion and penetrating to an inner portion of said annular corrugated hose body and between said first and second ends respectively coupled to said first and second end connectors.

19. The method of claim 16 wherein forming the electro-polished stainless steel into said annular corrugated hose body maintains a surface finish at or below RA16 μin.

20. A flexible conduit hose assembly of claim 1 further comprising a control volume within said hose body and said first and second end connectors such that the control volume maintains constant pressure when a fluid tight seal is added to the openings at the ends of the first and second end connectors.
